(19) United States
(12) Patent Application Publication
(10) Pub. No.: US 2026/0235720 A1
(43) Pub. Date: Aug. 13, 2026

(54) Methods and Apparatuses for Enabling Continued Sensing of an Object

(71) Applicant: Telefonaktiebolaget LM Ericsson (publ), Stockholm (SE)

(72) Inventors: Athanasios Karapantelakis, Athens (GR); Abdulrahman Alabbasi, Stockholm (SE); Danesh Daroui, Göteborg (SE); Hossein Shokri Ghadikolaei, Stockholm (SE); Jaeseong Jeong, Stockholm (SE); Konstantinos Vandikas, Stockholm (SE)

(21) Appl. No.: 19/154,138

(22) PCT Filed: Jun. 2, 2023
(86) PCT No.: PCT/SE2023/050545

§ 371 Date: Aug. 6, 2025

(30) Foreign Application Priority Data
Feb. 13, 2023 (GR) 20230100113

(51) Int. Cl. G01S 7/00; G01S 13/00; G01S 13/58; G01S 13/72; H04W 4/02

(52) U.S. Cl. CPC G01S 7/003; G01S 13/003; G01S 13/58; G01S 13/72; H04W 4/02

(57) ABSTRACT

Embodiments described herein relate to methods and apparatuses for enabling sensing of an object. A computer-implemented method in a target network node comprises: receiving a request from a source network node currently performing sensing of the object to handover sensing of the object to the target network node; obtaining an indication of a location of the object; determining, based on the indication of the location, whether the target network node can perform sensing of the object; and responsive to determining that the target network node can perform sensing of the object, starting sensing of the object.

### TECHNICAL FIELD

Embodiments described herein relate to methods and apparatuses for enabling sensing of an object.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Joint Communication and Sensing (JCAS) in 3GPP Mobile Networks is a technology to use spectrum already leased for communication purposes, for sensing objects. Objects can be sensed by one radar (for example, monostatic radar) or multiple radars (bi-static radar or multi-static radar). Given that base station may be used both for communication and sensing of objects, base stations (e.g. gNBs) may need to strike a balance in their use of spectrum resources between communication and sensing. The mobile network, and especially newer generations, comprises a densely deployed radio access network (RAN), with each (or most) radio site having antennas with radio sensing capabilities. Although currently only a static separation of spectrum for sensing and communication is considered, several research works have addressed a more dynamic spectrum separation, in which sensing and communication resources are reallocated based on demand. When it comes to communication session, a mobile device, also known as User Equipment (UE), may be reallocated from one radio cell to another by means of handover procedure, which is widely used and standardized.

### SUMMARY

When considering sensing of objects, there is no known procedure for transferring the sensing of one or more objects from one network node (e.g. cell) to another. As is the case with handovers of communication traffic, transferring of sensing may not only happen due to object mobility, i.e., object moving out of range or a cell and in range of another, but also due to resource shortage at the source cell (e.g. provided by a source base station). In the latter case, a source cell may be overloaded with high-throughput critical communication traffic, whereas another cell (e.g. provided by a target base station) may at the same time have resources available.

According to some embodiments there is therefore provided a computer-implemented method in a target network node for enabling sensing of an object. The method comprises receiving a request from a source network node currently performing sensing of the object to handover sensing of the object to the target network node; obtaining an indication of a location of the object; determining, based on the indication of the location, whether the target network node can perform sensing of the object; and responsive to determining that the target network node can perform sensing of the object, starting sensing of the object.

According to some embodiments there is provided a computer-implemented method in a source network node for enabling sensing of an object currently sensed by the source network node. The method comprises responsive to determining that the source network node will not be able to continue sensing the object, transmitting, to a target network node, a request to handover sensing of the object to the target network node.

According to some embodiments there is provided a target network node for enabling sensing of an object. The target network node comprises processing circuitry configured to cause the target network node to: receive a request from a source network node currently performing sensing of the object to handover sensing of the object to the target network node; obtain an indication of a location of the object; determine, based on the indication of the location, whether the target network node can perform sensing of the object; and responsive to determining that the target network node can perform sensing of the object, start sensing of the object.

According to some embodiments there is provided a source network node for enabling sensing of an object. The source network node comprises processing circuitry configured to cause the source network node to: responsive to determining that the source network node will not be able to continue sensing the object, transmit, to a target network node, a request to handover sensing of the object to the target network node.

Aspects and examples of the present disclosure thus provide methods and apparatus that enable continued sensing of an object even when a source network node is no longer able to continue sensing of an object. Embodiments described herein allow for continued sensing of object or objects in a greater geographical area than the coverage of a single radar or multi-radar setup. Embodiments described herein also allow for more accurate tracking of objects in case they are obstructed by temporal environmental phenomena (e.g., blockage of line of sight, rain, etc.).

For the purposes of the present disclosure, the term “Machine Learning, ML, model” encompasses within its scope the following concepts:
Machine Learning algorithms, comprising processes or instructions through which data may be used in a training process to generate a model artefact for performing a given task, or for representing a real world process or system;
the model artefact that is created by such a training process, and which comprises the computational architecture that performs the task; and
the process performed by the model artefact in order to complete the task. References to “ML model”, “model”, model parameters”, “model information”, etc., may thus be understood as relating to any one or more of the above concepts encompassed within the scope of “ML model”.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates a computer-implemented method in a target network node for enabling sensing of an object;

FIG. 2 illustrates a computer-implemented method in a source network node for enabling sensing of an object currently sensed by the source network node;

FIG. 3 illustrates an example of transfer of sensing of a mono-static radar;

FIG. 4a illustrates an example of a third relative location of a source network node to a target network node;

FIG. 4b illustrates an example of a second relative location of an object relative to a source network node;

FIG. 4c illustrates how the first relative location may be determined based on the second relative location and the third relative location;

FIG. 5 illustrates a sensing range of a target network node;

FIG. 6 illustrates an example implementation of the methods of FIGS. 2 and 3 in which bi-static radar is used to sense the object;

FIG. 7 illustrates a Dual Active Protocol Stack;

FIG. 8 illustrates an example in which the source network node may be able to identify a target network node's sensing availability/capability before initiating an X2AP Sensing Request;

FIG. 9 illustrates an network node 900 comprising processing circuitry;

FIG. 10 is a block diagram illustrating a target network node according to some embodiments;

FIG. 11 is a block diagram illustrating a source network node according to some embodiments.

### DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAS, etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g., digital or analogue) circuitry including but not limited to application specific integrated circuit(s) (ASIC) and/or field programmable gate array(s) (FPGA(s)), and (where appropriate) state machines capable of performing such functions.

Embodiments described herein provided methods and apparatuses for enabling sensing of an object. In particular, embodiments described herein provide for the transfer of sensing of an object from one cell to another (e.g. from a source network node to a target network node). As cell we define a geographical area covered by a network node (e.g. a base station), that may comprise an evolved Node-B (eNB), in case of fourth generation of mobile network (4G) or a 5G node-B (gNB) in case of a fifth generation of mobile network.

An object may comprise, for example: a road or aerial vehicle, a person, a structure such as a building. In some examples, some objects may be considered too small to sense effectively. An object may in some examples, comprise any object that has any dimension greater than approximately 10 cm. It will also be appreciated that some radars will be able to track larger objects than other radars.

The process for transferring sensing of an object from a source network node to a target network may be triggered by inaccurate sensing of the object, for example, because the object is out of range or because there is a blockage in the Line of Sight (LoS) between the object and the radar(s) on the source network node. An X2 application protocol (AP) may be used to implement the transfer sensing request/response messages, in a similar fashion to already supported handover request messages used for communication session handover between base stations.

Some embodiments may utilize a neighbor relations table already implemented in base stations such as evolved Node-B (eNB)/5G Node-B (gNB), wherein every eNB/gNB maintains a list of neighboring base stations.

Upon triggering of a process to transfer sensing of an object from a source network node to a target network node, the source network node may request resources from the target network node in a sensing handover request, similar to the communication handover request described in 3GPP TS 36.423 v 17.3.0.

It will be appreciated that in some embodiments the object is sensed by a single radar, also known as mono-static radar and the transfer of sensing is between two mono-static radars. However, in some other embodiments, the object is sensed by multiple radars (bi-static radar or multi-static radar) and the transfer of sensing is from at least one of the said multiple radars to another radar not already involved in the sensing of the object.

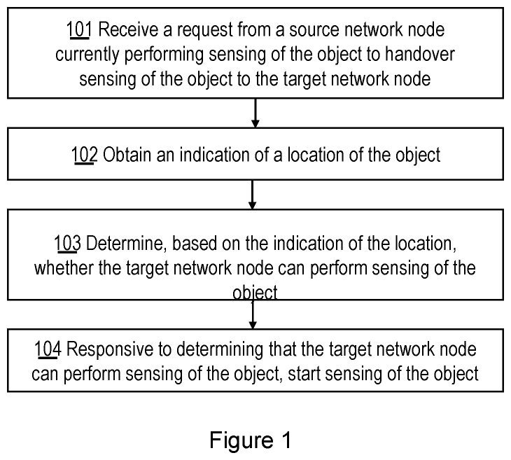

FIG. 1 illustrates a computer-implemented method in a target network node for enabling sensing of an object. It will be appreciated that herein sensing of an object may refer to performing target classification of the object and/or to tracking the location of the object.

Target classification of an object may comprise for example, identifying a composition of material within an object and/or dimensions of an object. The target classification may comprise utilizing one or more of: a ML approach that uses wavelet scattering feature extraction coupled with a support vector machine, transfer learning using SqueezeNet, and a Long Short-Term Memory (LSTM) recurrent neural network for performing the classification.

The method 100 may be performed by a target network node, which may comprise a physical or virtual node, and may be implemented in a computing device or server apparatus and/or in a virtualized environment, for example in a cloud, edge cloud or fog deployment. It will be appreciated that the target network node may comprise a base station (e.g. an eNB or a gNB), a/or Radio Access Network (RAN) node, an WiFi access point, and/or that the target network node may be distributed.

In step 101 the method comprises receiving a request from a source network node currently performing sensing of the object to handover sensing of the object to the target network node.

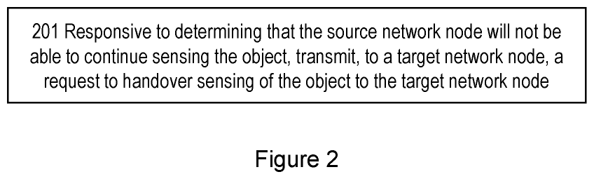

In step 102, the method comprises obtaining an indication of a location of the object. The indication of the location of the object may comprise a first relative location of the object relative to the target network node. For example, as described later with reference to FIG. 2, the target network node may determine the location of the object based on a second relative location of the object relative to the source network node and a third relative location of the source network node relative to the target network node.

In step 103, the method comprises determining, based on the indication of the location, whether the target network node can perform sensing of the object. For example, step 103 may comprise determining whether the object will remain within a sensing range of the target network node for at least a predetermined period of time. Step 103 may, in some examples, also comprise a determination of whether a predicted bandwidth that will be available for sensing the object at the target network node is sufficient. In other words, step 103 may comprise determining whether the predicted available bandwidth at the target network node is greater than or equal to a bandwidth required to sense the object.

In step 104, the method comprises responsive to determining that the target network node can perform sensing of the object, starting sensing of the object.

FIG. 2 illustrates a computer-implemented method in a source network node for enabling sensing of an object currently sensed by the source network node.

The method 200 may be performed by a network node, which may comprise a physical or virtual node, and may be implemented in a computing device or server apparatus and/or in a virtualized environment, for example in a cloud, edge cloud or fog deployment. It will be appreciated that the source network node may comprise a base station (e.g. an eNB or a gNB), and/or a Radio Access Network (RAN) node, a WiFi access point, and/or that the source network node may be distributed.

In step 201, the method comprises, responsive to determining that the source network node will not be able to continue sensing the object, transmitting, to a target network node, a request to handover sensing of the object to the target network node.

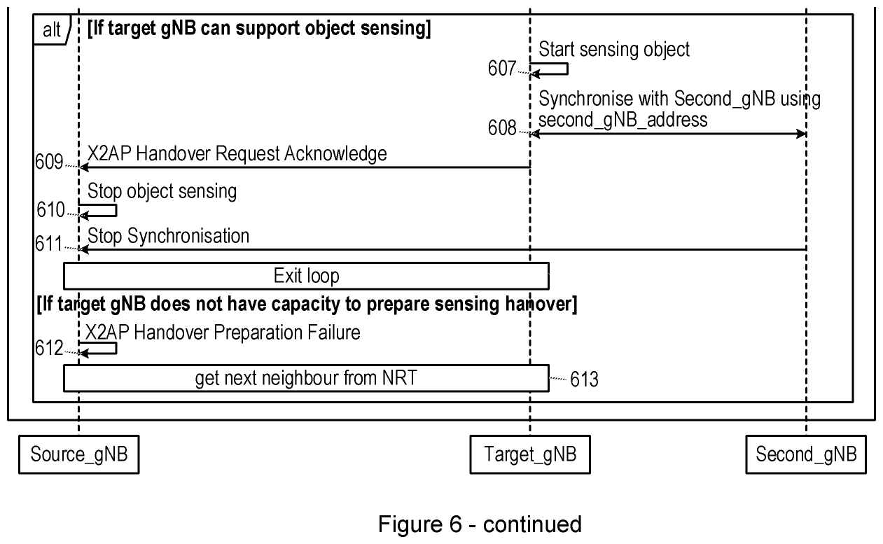

The request may be transmitted using X2 interface between the target network node and the source network node. In some examples, the target network node may be selected from a Neighbor Relations Table (as described in more detail with reference to FIG. 6)

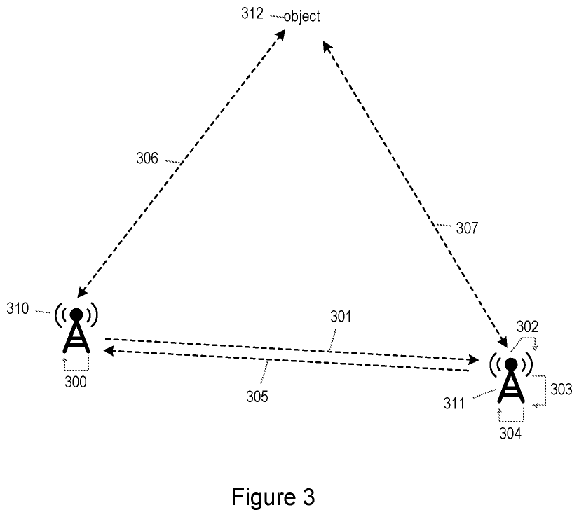

The method of FIG. 2 may in some examples further comprise determining that the source network node will not be able to continue sensing the object. This determination may, in some examples, be made based on whether or not available bandwidth for sensing at the source network node will be sufficient to continue sensing of the object. Methods for predicting the available bandwidth for sensing at the source network node will be described later with reference to FIG. 3.

The determination that the source network node will not be able to continue sensing the object may, in some examples, be additionally or alternatively based on whether or not the object will remain within a sensing range of the source network node for at least a predetermined period of time. A sensing range may be understood as a geographical area within which the object may continue to be sensed by the source network node.

For example, the source network node may determine that the source network node will not be able to continue sensing the object based on one or more of: available bandwidth for sensing at the source network node, a velocity of the object, a direction of travel of the object and a second relative location of the object relative to the source network node.

In some examples, the request of step 201 may comprise properties of the object. For example, the request may comprise an indication of a second relative location of the object relative to the source network node.

In some examples, the request of step 201 comprises an indication of the velocity of the object and the direction of travel of the object.

In some examples, the request further comprises an indication of the bearing of the object with respect to a predetermined axis (e.g. West).

In addition, several characteristics of the sensing beacon signalling may be transmitted in the request of step 201. In other words, information regarding the design of the sensing beacons may be transmitted in step 201, which may then help the target network node in configuring its own beacon transmission. For example, the request may comprise an indication of the carrier frequency the source network node is using for tracking, the bandwidth, the pulses per measurement and the time of repetition between two consecutive pulses

FIG. 3 illustrates an example of transfer of sensing of a mono-static radar. In this example, a source network node 310 hands over sensing of an object 312 to a target network node 311. FIG. 3 illustrates an example implementation of the methods of FIGS. 1 and 2.

In step 300, the source network node determines that it will not be able to continue sensing the object. For example, the source network node may determine that the source network node will not be able to continue sensing the object based on one or more of: available bandwidth for sensing at the source network node, a velocity of the object, a direction of travel of the object and a second relative location of the object relative to the source network node.

In step 301, the target network node 311 receives a sensing handover request from the source network node 310. The sensing handover request may be transmitted over an X2 interface between the source network node and the target network node. Step 301 comprises an example implementation of step 101 of FIG. 1 and step 201 of FIG. 2. It will be appreciated that the target network node may be selected from a NRT (as described in more detail with reference to FIG. 6).

In some examples, the request may comprise properties of the object 312. For example, the request may comprise an indication of a second relative location of the object relative to the source network node.

The method of FIG. 3 may also comprise obtaining a velocity of the object and a direction of travel of the object. In some examples, the request of step 301 comprises an indication of the velocity of the object and the direction of travel of the object.

In some examples, the request further comprises an indication of the bearing of the object with respect to a predetermined axis (e.g. West).

In addition, several characteristics of the sensing beacon signalling may be transmitted in the request of step 301. In other words, information regarding the design of the sensing beacons may be transmitted in step 301, which may then help the target network node in configuring its own beacon transmission. For example, the request may comprise an indication of the carrier frequency the source network node is using for tracking, the bandwidth, the pulses per measurement and the time of repetition between two consecutive pulses. These characteristics of the sensing beacon may be utilised by the target network node 311 determining whether or not the target network node has the capability (e.g. bandwidth) to perform sensing using the same or similar characteristics to those that were used by the source network node 310.

In step 302, the target network node 311 may then obtain a third relative location of the source network node 310 relative to the target network node 311. For example, Given that the X2 interface is implemented over point-to-point links (e.g. a microwave link), with a direct line of sight, the target network node may calculate its distance from the source network node as well as the source network node's relative location to the target network node.

For example, the target network node may utilise an indication of a time taken for signalling to travel between the source network node and the target network node to determine a distance between the source network node and the target network node. The direction of the location of the source network node may then be determined based on the directional link between the source network node and the target network node.

In some examples however, step 302 may comprise obtaining the third relative location of the source network node 310 relative to the target network node 311 from an Operations Support System (OSS). The OSS may provide geographical coordinates of the source network node and the target network node to the target network node. The target network node may then calculate the haversine distance between them.

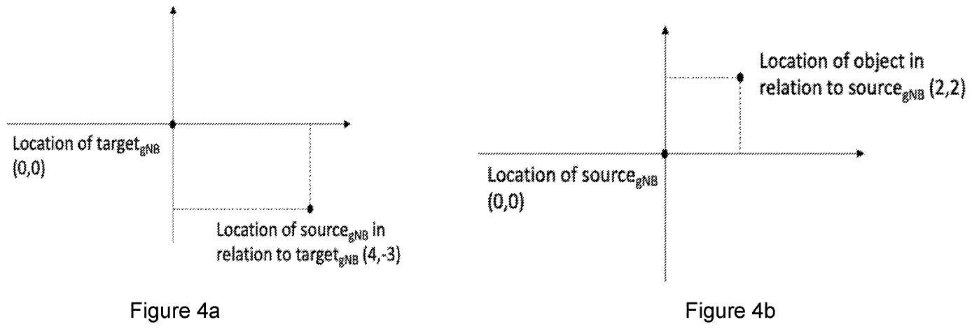

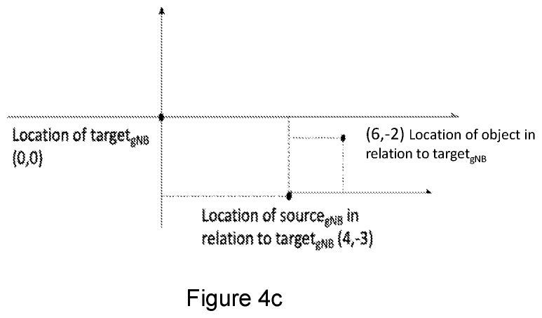

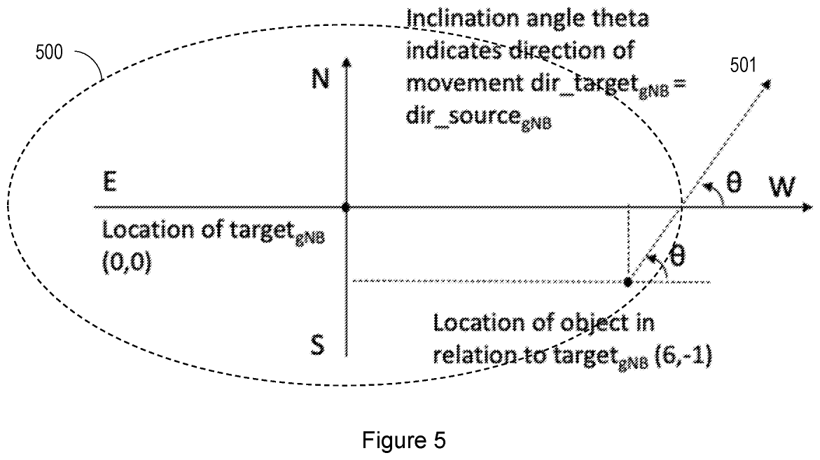

FIG. 4a illustrates an example of a third relative location of a source network node 310 to a target network node 311. In this example, the relative location of the source network node to the target network node is at coordinates (4, −3) metres.

In step 303, the target network node 311 may then determine a first relative location of the object 312 relative to the target network node based on the second relative location and the third relative location. Step 303 comprises an example implementation of step 102 of FIG. 1.

FIG. 4b illustrates an example of a second relative location of an object relative to a source network node. In this example, the second relative location of the object relative to the source network node is (2, 2) metres.

FIG. 4c illustrates how the first relative location may be determined based on the second relative location and the third relative location.

In this example, there the first relative location is equal to the second relative location plus the third relative location, which, in this example, is at coordinates (6, −1) metres relative to the target network node.

The target network node 311 may then, in step 304, determine, based on the first relative location of the object 312 relative to the target network node, whether the target network node can perform sensing of the object. This determination comprises an example implementation of step 103 of FIG. 1.

In some examples, step 304 may comprise determining whether the first relative location indicates that the object 312 is within a sensing range of the target network node. If the object is within the sensing range of the target network node, the target network node may determine that it can perform sensing of the object.

However, in some examples, the target network node may further consider whether or not the object will remain in the sensing range of the target network node for a predetermined time. For example, it may be beneficial to avoid handing over sensing of the object to a target network node if the object will have moved out of the sensing range of the target network node by the time the handover has been completed.

For example, where the request in step 301 comprises an indication of the velocity of the object and the direction of travel of the object, step 304 may comprise determining, based on the location, the velocity, and the direction of travel of the object whether the object will remain with a sensing range of the target network node for at least a predetermined period of time.

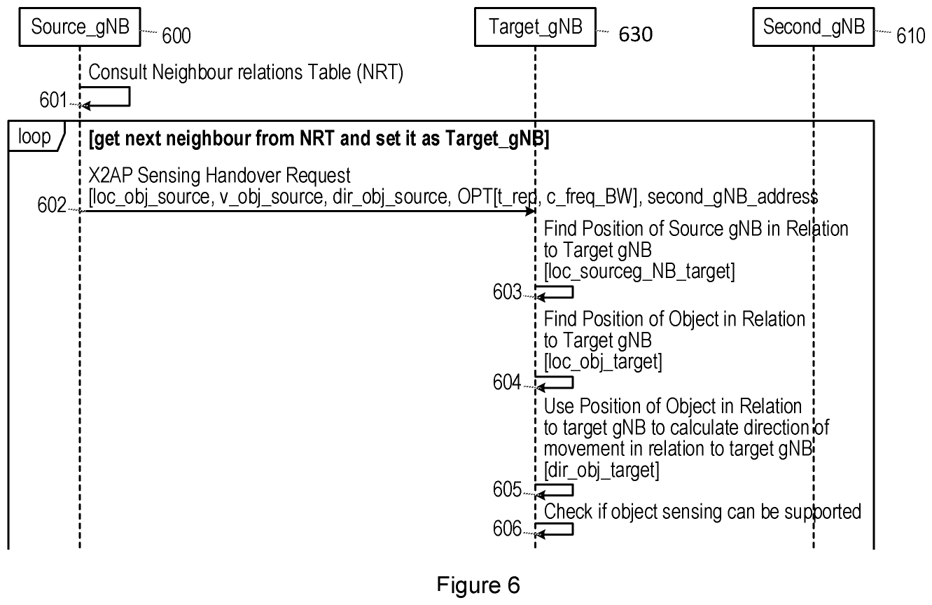

FIG. 5 illustrates a sensing range 500 of a target network node. In FIG. 5 the location of the object 312 at a current time is illustrated. The object is located at coordinated (6, −1) metres relative to the location of the target network node.

At this point in time, it can be seen that the object is within the sensing range 500 of the target network node. However, the object is travelling in the direction indicated by the arrow 501 at an angle of θ to the x-axis (which is, in this example, defined as being West).

It will be appreciated that based on the direction 501, the sensing range of the target network node 311, and the velocity of the object 312, the target network node may be able to determined at what time, the object will move out of the sensing range 500.

If the time that the object is predicted to remain within the sensing range 500 is greater than the predetermined time, then the target network node may determine that the object can be sensed by the target network node in step 304.

In some examples, additionally or alternatively, step 304 may comprise determining whether the target network node can perform sensing of the object is further based on a predicted available bandwidth for sensing at the target network node.

For example, the target network node may determine whether it has enough available spectrum to be able to transmit the beacons required to sense the object. The beacons required may be determined based on information received from the source network node regarding the resources that the source network node is currently using to sense the object. Regardless of whether the bandwidth dedicated to sensing is statically allocated (e.g., by design/configuration of the operator), or dynamically allocated based on demand, the target network node may know how much (e.g., in terms of percentage) spectrum is utilized by current sensing/communication services and therefore, how much bandwidth is currently available.

In some embodiments a statistical method such as averaging may be used over a certain set of previous measurements of the available bandwidth over a period (e.g., the last 5 minutes), and based on that average, the target network node 311 may be able to provide a prediction for the available bandwidth. For example, step 304 may comprise determining an average of previous available bandwidth over a predetermined number of previous measurements of available bandwidth to predict the predicted available bandwidth.

For example, a ML model, for example a deep neural network, a logistic regression, a polynomial regression, a Bayesian linear regression or a gradient boosting regression may be used to predict the available bandwidth. The advantage of an ML approach over the a statistical method such as averaging, is that the ML model can have more inputs than the historical capacity—for example time and date can be used to detect seasonal patterns. However, the embodiment of a statistical method described above may be advantageous in that it requires less input data and less processing power.

It will be appreciated that the methods described herein for determining the available bandwidth at the target network node may be equally applied at the source network node for determining whether to trigger handover of the sensing of the object.

Once the available bandwidth and the predicted available bandwidth has been determined, the target network node 311 may decide whether it has the capacity to support sensing of the new object 312, either by designing its own parameters of beacon design (in terms of inter-transmission time, transmission frequency and bandwidth allocated to a beacon) or by consulting and reusing numerology received in the request received in step 301. In other words, the target network node may check that is has sufficient resources (e.g. bandwidth, frequency, periodicity of pulses) to sense the object.

For example, the target network node may predict the bandwidth that will be available at the target network node for the period that the object is due to remain within the sensing range 500. If the predicted available bandwidth will not be enough to continue sensing the object for that period, the target network node may determine that the target network node cannot perform sensing of the object.

In some examples, additionally or alternatively, step 304 may comprise determining whether the target network node 311 can perform sensing of the object is further based on available processing capacity for sensing at the target network node. For example the available processing capacity may be expressed in terms of, for example, a load on a central processing unit at the target network node.

If in step 304, the target network node 311, determines that the target network node can perform sensing of the object, the target network node transmits, in step 305, an indication to the source network node 310 that the sensing is to be performed by the target network node. It will be appreciated that in some examples, the indication of step 305 may be transmitted responsive to the target network node starting sensing the object 312.

Responsive to receiving the indication in step 304, the source network node 310 stops sensing the object 312 in step 306.

In step 307, the target network node 311 starts sensing of the object 312. Step 307 comprises an example implementation of step 104 of FIG. 1.

As described above, in some embodiments bi-static radar or multi-static radar is used. In these examples, the request to handover sensing may also comprise one or more addresses of other network nodes tracking the object so that the target network node may synchronize with them to perform the sensing of the object.

FIG. 6 illustrates an example implementation of the methods of FIGS. 2 and 3 in which bi-static radar is used to sense the object. It will be appreciated that the concepts described here with reference to the bi-static example may be applicable to multi-static examples and, in some cases to the mono-static examples.

Initially, the bi-static radar is being performed by a source network node 600 and a second network node 630.

In this example, a precondition may apply in which the source network node 600 has determined that it should handover sensing of the object to another network node. For example, the source network node 600 may determine that inaccurate sensing has occurred. Inaccurate sensing may for example mean that a small subset of beacons transmitted are reflected to the radar, as the line of sight is blocked, or the object is moving out of range. In such cases, the ratio of reflected beacons to transmitted beacons should be quite low, lower than a threshold set by design. In other examples, the source network node may determine that handover of sensing should occur because of trigger described above with reference to FIGS. 2 and 3.

In step 601, the source network node 600 selects the target network node 620 from a list of one or more neighbor network nodes. For example, the source network node 600 may poll a neighbour relationships table (NRT) to select a neighbor network node as the target network node 620 to try to handover sensing of the object to.

In step 602, the source network node 600 transmits a request to the target network node 620 to handover sensing of the object. The request may comprise an X2 Sensing Handover Request. Step 602 comprises an example implementation of step 101 of FIG. 1 and step 201 of FIG. 2. It will be appreciated that the request of step 602 comprises an address of the second network node 630 involved in sensing the object.

The X2 Sensing Handover Request may comprise some or all of the information indicated in table 1 below:

TABLE 1
X2AP Sensing Handover Request parameters

| Parameter | | Optional/ | | |
|---|---|---|---|---|
| Name | Description | Mandatory | Example Value | |
| Location_obj_source | The location of the object | M | [4, 5] (4 meters east, 5 | |
| | being sensed, related to | | meters north - see also | |
| | source gNB/eNB | | 6.2.2). Other metric can | |
| | | | also use elevation of object | |
| | | | in relation to gNB (e.g., 1 | |
| | | | meter higher). | |
| Velocity_obj_source | The velocity and | M | [10, 0] - 10 meters per | |
| | acceleration of the object | | second constant, [10, 2] 10 | |
| | being sensed | | meters per second with | |
| | | | acceleration 2 m/sec | |
| Direction_obj_source | The direction of movement, | M | 1π/6-30 degrees | |
| | or trajectory, expressed | | | |
| | e.g., as an angle (radians) | | | |
| | indicating inclination from | | | |
| | east-west axis. | | | |
| T_rep | The time between beacon | O | 2 | ms |
| | transmission | | | |
| C_freq | The frequency where | O | 1 | THz |
| | beacon is transmitted | | | |
| BW | The bandwidth of the | O | 2 | Hz |
| | beacon | | | |

In step 603, the target network node 620 determines the third relative location (e.g. as described above with reference to step 302 of FIG. 3).

In step 604, the target network node 620 determines the first relative location (e.g. as described above with reference to step 303 of FIG. 3).

In step 605, the target network node 620 may determine the direction of movement of the object in relation to the target network node. For example, as described with FIG. 3 and FIG. 5.

In step 606, the target network node 620 determines whether sensing of the object can be supported for example as described with reference to step 304 of FIG. 3.

In some examples may additionally or alternatively comprise determining whether an accuracy metric associated with sensing at the target network node being greater than an accuracy metric associated with sensing at the source network node by at least a threshold amount. The threshold amount may be tracked by both the source network node and the target network node. It will be appreciated that the target network node may be allowed to presume responsibility of sensing of object if its accuracy of sensing is increased over the accuracy of sensing of the source network node more than the threshold amount.

The accuracy metric may comprise for example the smallest dimension of object that can be sensed. The accuracy metric may comprise for example, a statistical error (e.g. average and/or variance) in a location estimation as a function of the object dimensions.

In step 607 the target network node 620 starts sensing the object.

In step 608, the target network node 620 synchronizes with the second network node 630 to perform the sensing. For example, the second network node 600 and the target network node may agree that they are tracking the same object to provide continuity in the scope of this process. In some examples, if this synchronisation cannot be performed the procedure may be cancelled and another target network node may be selected by the source network node.

In step 609, target network node 620 transmits, to the source network node 600, an indication that the target network node 620 is now performing sensing of the object.

In step 610, responsive to receiving the indication in step 409, the source network node 600 stops sensing the object.

In step 611, the second network node may and synchronisation with the source network node.

If target network node 620 determines in step 606 that it does not have capacity to sense the object the target network node 620 may transmit an indication that sensing cannot be performed by the target network node 620 to the source network node 600.

Alternatively, if, after a predetermined period, no acknowledgement of a successful handover of sensing has been received at the source network node 600, the source network node 600 may determine that the handover has failed, in step 612.

In step 613, the source network node may then select another target network node from the NRT, and the process of FIG. 6 may repeat until a successful handover if achieved.

In some examples, in particular where the sensing of the object comprises target classification, a Dual Active Protocol Stack (DAPS) protocol may be utilised to transmit ML model information (for example, ML model parameters for implementation of a ML model) from the source network node to the target network node to enable the target network node to continue sensing the object using the ML model information. It will be appreciated that the ML model may be utilised to perform target classification of an object. For example, in case of a neural network, transfer learning could be used to transmit the configuration of the neural network (number of layers, number of neutrons per layer, activation function and weights of each neutron)

The DAPS protocol has been proposed for communication handover to reduce handover interaction time (HIT). In some examples, the DAPS protocol is extended to a simpler Dual Active Sensing Protocol (DASP) to handover sensing activity.

By using DAPS to adopt DASP, the following signals from the description of DAPS in 3GPP TS 38.300 v 17.3.0 are altered:
1. The Measurement Report is changed to a sensing report
2. The Handover (HO) decision is changed to Sensing HO decision.
3. The HO Request is changed to Sensing HO Request
5. The RRC Reconfiguration is removed if Sensing to be considered as L1 function, unless it is RRC function, then it can be considered in RRC Reconfig.
6. The HO status information transfer becomes a Sensing HO Status Information Transfer.

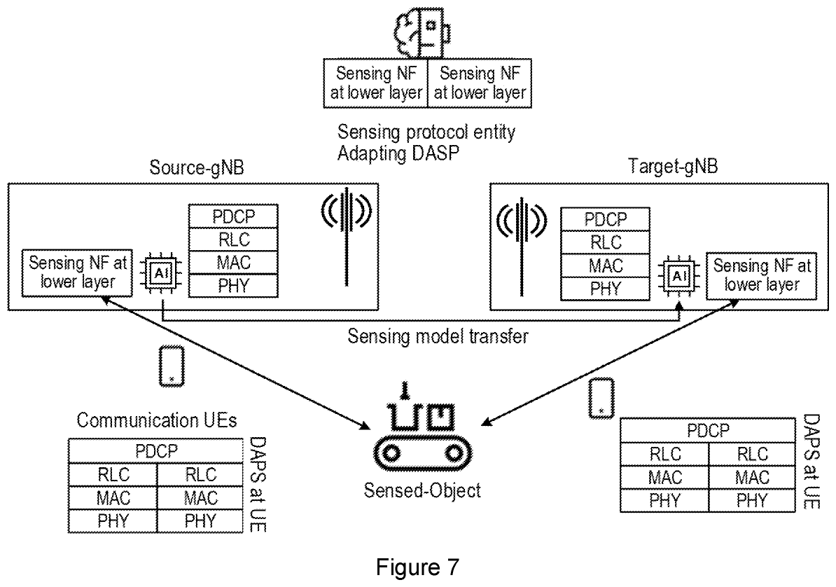

Unlike DAPS (which is illustrated in FIG. 7), DASP does not require full stack connectivity, instead it only requires PHY MAC attachment process. Note that this may only work in multi/bi static radar. For multi/bi static radar, the “handover”, even though some resources are wasted, may occur without interruption. In other words, in the bi/multi-static radar case, one of the other radars can continue sensing the object even after “handover” process was initiated.

In FIG. 6, based on the NRT, the source network node may poll its neighbors for suitability to perform the handover of the object being sensed.

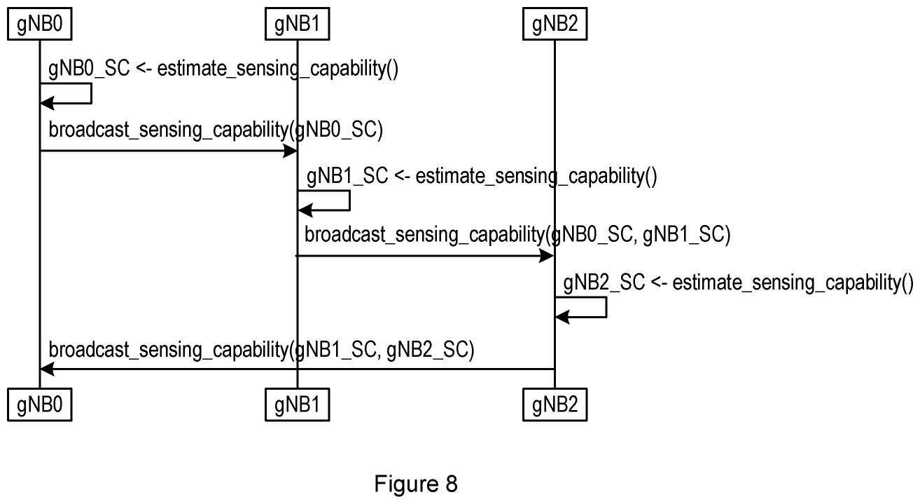

FIG. 8, however, illustrates an example in which the source network node may be able to identify a target network node's sensing availability/capability before initiating an X2AP Sensing Request.

The method described in FIG. 8 may overcome issues relating to session establishment in scenarios in which the target network node is not available or capable of performing the sensing.

In this example three network nodes gNB0, gNB1 and gNB2 belong to the same neighborhood or, in other words, may have X2 links and active cell relationships. gNB0 may be seen as a capacity cell or a cell that can be power saved via a cell lock and radio deep sleep. gNB1 may be a coverage cell which is tasked to handle traffic from gNB0 when that cell is asleep, and gNB2 may belong to a resource pool of backup cells which can be either capacity or coverage cells.

Given this arrangement of cells it may be assumed that the coverage between these cells overlaps, and it is the case that such cells are covering the same area.

In this example, the network nodes may transmit sensing capability information to one or more neighboring network nodes. The sensing capability information may be transmitted in periodic reports. For example, as illustrated in FIG. 8, a bounded gossip protocol may be utilised.

Each network node may measure its capability for sensing (for example, as described previously with reference to FIGS. 2 to 6) and report it to the next network node in the protocol, and so on. Based on the sensing capability information each network node may have an idea about potential candidate target network nodes that could be used for the process of transferring or delegating sensing actions.

The boundary of the gossip protocol may be limited to those network nodes that share a cell relationship or have an X2 link. Object sensing capability may refer to the actual capability to perform sensing but also to whether the target network node may offer physical resource blocks for sensing instead of communication. In a different embodiment, instead of providing a binary indication about the sensing capability/availability, the network nodes may also provide a time slot in the future where sensing might be possible. In other words, the sensing capability information may comprise one or more of: an indication that the target network node is capable of performing sensing, an available bandwidth for sensing at the target network node; a future time slot during which sensing at the target network node is likely to be possible.

In some examples, the sensing capability information may further comprise one or more identifiers associated with one or more objects (e.g. UEs) that can be sensed by that network nodes. The source network node may then handover sensing of the objects to a target network node that identified the object in the sensing capability information. This improves the likelihood that the objects may continue to be sensed without any gaps in their surveillance.

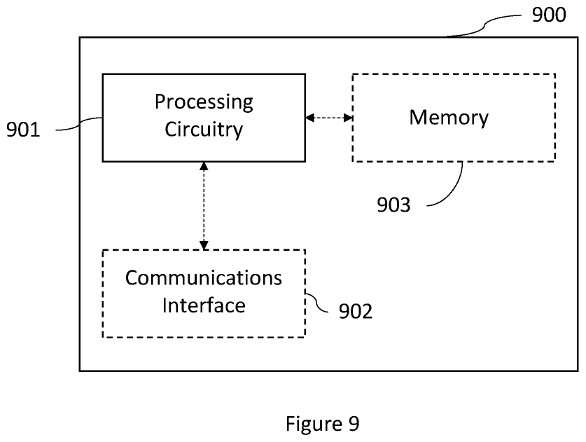

FIG. 9 illustrates an network node 900 comprising processing circuitry (or logic) 901. The processing circuitry 901 controls the operation of the network node 900 and can implement the method described herein in relation to an network node 900. The processing circuitry 901 can comprise one or more processors, processing units, multi-core processors or modules that are configured or programmed to control the network node 900 in the manner described herein. In particular implementations, the processing circuitry 901 can comprise a plurality of software and/or hardware modules that are each configured to perform, or are for performing, individual or multiple steps of the method described herein in relation to the network node 900. It will be appreciated that the network node 900 may comprise one or more virtual machines running different software and/or processes. The network node 900 may therefore comprise, or be implemented in or as one or more servers, switches and/or storage devices and/or may comprise cloud computing infrastructure that runs the software and/or processes.

Briefly, the processing circuitry 901 of the network node 900 is configured to perform the method as described herein with reference to any of a source network node or a target network node.

In some embodiments, the network node 900 may optionally comprise a communications interface 902. The communications interface 902 of the network node 900 can be for use in communicating with other nodes, such as other virtual nodes. For example, the communications interface 902 of the network node 900 can be configured to transmit to and/or receive from other nodes requests, resources, information, data, signals, or similar. The processing circuitry 901 of network node 900 may be configured to control the communications interface 902 of the network node 900 to transmit to and/or receive from other nodes requests, resources, information, data, signals, or similar. The communications interface 902 can use any suitable communication technology.

Optionally, the network node 900 may comprise a memory 903. In some embodiments, the memory 903 of the network node 900 can be configured to store program code that can be executed by the processing circuitry 901 of the network node 900 to perform the method described herein in relation to the network node 900. Alternatively or in addition, the memory 903 of the network node 900, can be configured to store any requests, resources, information, data, signals, or similar that are described herein. The processing circuitry 901 of the network node 900 may be configured to control the memory 903 of the network node 900 to store any requests, resources, information, data, signals, or similar that are described herein. The network node 900 may be configured operate in the manner described herein in respect of an network node.

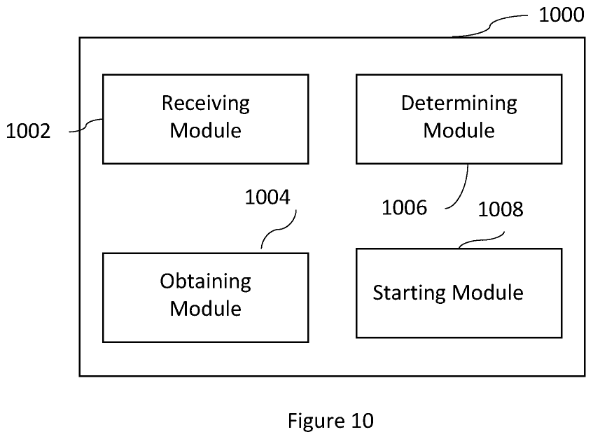

FIG. 10 is a block diagram illustrating a target network node 1000 according to some embodiments. The target network node 1000 can enable sensing of an object. The target network node 1000 comprises a receiving module 1002 configured to receive a request from a source network node currently performing sensing of the object to handover sensing of the object to the target network node. The target network node 1000 comprises an obtaining module 1004 configured to obtain an indication of a location of the object. The target network node further comprises a determining module 1006 configured to determine, based on the indication of the location, whether the target network node can perform sensing of the object. The target network node further comprises a starting module 1008 configured to responsive to determining that the target network node can perform sensing of the object, start sensing of the object. The target network node 1000 may operate in the manner described herein in respect of an target network node.

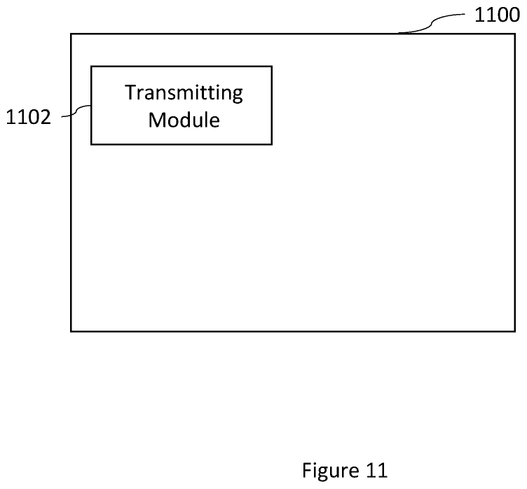

FIG. 11 is a block diagram illustrating a source network node 1100 according to some embodiments. The source network node 1100 can enable sensing of an object. The source network node 1100 comprises a transmitting module 1102 configured to responsive to determining that the source network node will not be able to continue sensing the object, transmit, to a target network node, a request to handover sensing of the object to the target network node. The source network node 1100 may operate in the manner described herein in respect of an source network node.

There is also provided a computer program comprising instructions which, when executed by processing circuitry (such as the processing circuitry 901 of the network node 900 described earlier), cause the processing circuitry to perform at least part of the method described herein. There is provided a computer program product, embodied on a non-transitory machine-readable medium, comprising instructions which are executable by processing circuitry to cause the processing circuitry to perform at least part of the method described herein. There is provided a computer program product comprising a carrier containing instructions for causing processing circuitry to perform at least part of the method described herein. In some embodiments, the carrier can be any one of an electronic signal, an optical signal, an electromagnetic signal, an electrical signal, a radio signal, a microwave signal, or a computer-readable storage medium.

Embodiments described herein allow for continued sensing of object or objects in a greater geographical area than the coverage of a single radar or multi-radar setup.

Embodiments described herein also allow for more accurate tracking of objects in case they are obstructed by temporal environmental phenomena (e.g., blockage of line of sight, rain, etc.).

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1.-41. (canceled)

42. A computer-implemented method in a target network node for enabling sensing of an object, the method comprising:
receiving, from a source network node currently performing sensing of the object, a request to handover sensing of the object to the target network node;
obtaining an indication of a location of the object;
determining, based on the indication of the location, whether the target network node can perform sensing of the object; and
responsive to determining that the target network node can perform sensing of the object, starting sensing of the object.

43. The computer-implemented method as claimed in claim 42, wherein the indication of the location comprises a first relative location of the object relative to the target network node, wherein the request comprises an indication of a second relative location of the object relative to the source network node, and wherein the step of obtaining the indication of the location of the object comprises:
obtaining a third relative location of the source network node relative to the target network node; and
determining the first relative location based on the second relative location and the third relative location.

44. The computer-implemented method as claimed in claim 42, further comprising obtaining a velocity of the object and a direction of travel of the object, and wherein the step of determining whether the target network node can perform sensing of the object comprises:
determining, based on the location, the velocity and the direction of travel whether the object will remain with a sensing range of the target network node for at least a predetermined period of time; and
determining whether the target network node can perform sensing of the object based on whether the object will remain with the sensing range of the target network node for at least the predetermined period of time.

45. The computer-implemented method as claimed in claim 42, wherein the sensing of the object comprises one or more of:
performing target classification of the object; and
tracking the location of the object.

46. The computer-implemented method as claimed in claim 42, further comprising performing the step of starting sensing the object responsive to an accuracy metric associated with sensing at the target network node being greater than an accuracy metric associated with sensing at the source network node by at least a threshold amount.

47. The computer-implemented method as claimed in claim 42, wherein the step of determining whether the target network node can perform sensing of the object is further based on:
a predicted available bandwidth for sensing at the target network node; and/or
available processing capacity for sensing at the target network node.

48. The computer-implemented method as claimed in claim 47, wherein the step of determining whether the target network node can perform sensing of the object is further based on the predicted available bandwidth for sensing at the target network node, wherein the method further comprises predicting the predicted available bandwidth by:
utilizing a machine learning model to predict the predicted available bandwidth; or
determining an average of previous available bandwidth over a predetermined number of previous measurements of available bandwidth to predict the predicted available bandwidth.

49. The computer-implemented method as claimed in claim 42, further comprising transmitting sensing capability information to one or more neighboring network nodes, wherein the sensing capability information comprises one or more of:
an indication that the target network node is capable of performing sensing;
an available bandwidth for sensing at the target network node; or
a future time slot during which sensing at the target network node is likely to be possible.

50. The computer-implemented method as claimed in claim 42, wherein the request comprises an address of a second network node involved in sensing the object, and wherein the step of starting sensing the object comprises synchronizing with the second network node to perform the sensing.

51. The computer-implemented method as claimed in claim 42, further comprising, responsive to starting sensing of the object, transmitting an indication to the source network node that the sensing is being performed by the target network node.

52. The computer-implemented method as claimed in claim 42, wherein the object comprises one of: a road or ariel vehicle, a person, or a building.

53. A computer-implemented method in a source network node for enabling sensing of an object currently sensed by the source network node, the method comprising:
responsive to determining that the source network node will not be able to continue sensing the object, transmitting, to a target network node, a request to handover sensing of the object to the target network node.

54. The computer-implemented method as claimed in claim 53, wherein the step of determining that the source network node will not be able to continue sensing the object is based on one or more of:
available bandwidth for sensing at the source network node;
a velocity of the object;
a direction of travel of the object; or
a second relative location of the object relative to the source network node.

55. The computer-implemented method as claimed in claim 54, wherein the step of determining that the source network node will not be able to continue sensing the object is based on the available bandwidth for sensing at the source network node, wherein the method further comprises determining the available bandwidth by:
utilizing a machine learning model to predict the available bandwidth; or
determining an average of previous available bandwidth over a predetermined number of previous samples to predict the available bandwidth.

56. The computer-implemented method as claimed in claim 54, wherein the request comprises one or more of:
the second relative location of the object relative to the source network node;
the velocity of the object; or
the direction of travel of the object.

57. The computer-implemented method as claimed in claim 53, wherein the sensing of the object comprises one or more of performing target classification of the object and tracking the location of the object.

58. The computer-implemented method as claimed in claim 53, further comprising:
responsive to the target network node starting sensing of the object, receiving an indication that the sensing is being performed by the target network node; and
responsive to receiving the indication, stopping sensing of the object.

59. The computer-implemented method as claimed in claim 53, further comprising:
receiving sensing capability from one or more neighboring network nodes, wherein the sensing capability comprises one or more of:
an indication that the target network node is capable of performing sensing;
an available bandwidth for sensing at the target network node; or
a future time slot during which sensing at the target network node is likely to be possible; and
selecting the target network node from the one or more neighbor network nodes, based on the received sensing capability.

60. A target network node for enabling sensing of an object, the target network node comprising processing circuitry configured to cause the target network node to:
receive, from a source network node currently performing sensing of the object, a request to handover sensing of the object to the target network node;
obtain an indication of a location of the object;
determine, based on the indication of the location, whether the target network node can perform sensing of the object; and
responsive to determining that the target network node can perform sensing of the object, start sensing of the object.

61. A source network node for enabling sensing of an object, the source network node comprising processing circuitry configured to cause the source network node to:
responsive to determining that the source network node will not be able to continue sensing the object, transmit, to a target network node, a request to handover sensing of the object to the target network node.
